(19) United States
(12) Patent Application Publication
(10) Pub. No.: US 2012/0205445 A1
(43) Pub. Date: Aug. 16, 2012

(54) ELECTRONIC PAYMENT USING OPTICALLY READABLE SYMBOLS

(75) Inventor: Leigh M. Rothschild, Sunny Isles Beach, FL (US)

(73) Assignee: ARIEL INVENTIONS, LLC, Sunny Isles Beach, FL (US)

(21) Appl. No.: 13/025,149

(22) Filed: Feb. 10, 2011

(51) Int. Cl. G06K 15/00

(52) U.S. Cl. 235/383

(57) ABSTRACT

A method, using a computer and visual scanning device attached to the computer is disclosed. A visual invoice from a provider is scanned with the visual scanning device, and the visual invoice includes an optically readable symbol. The request is sent to a trusted agent using the optically readable symbol. An electronic invoice is received from the trusted agent based upon the request. The electronic invoice is then approved.

### BACKGROUND OF THE INVENTION

The disclosure relates generally to electronic payment processing and, more specifically, to electronic payment of invoices using optically readable symbols. Credit cards are ubiquitous in modern society, and as a result, credit cards have been targeted for use in fraudulent activities. In response, many different types of safeguards have been put in place to prevent the fraudulent use of credits cards. For example, when a user makes credit card purchases online, the credit card transaction is encrypted and may require the use of a security code associated with the particular credit card being used. When shopping in public, consumers take great care to maintain the possession of their credit card and will immediately contact the credit card issuer upon noticing that the card has been lost or stolen. Also, when handing the credit card over to a merchant at a checkout counter, the numbers of the credit card are automatically read into the checkout system and the entire transaction takes place automatically without the need for human intervention, which prevents the credit card information from being compromised.

Despite these and many other safeguards, credit card fraud is still a major issue. One reason why credit card fraud is still readily prevalent is that there are situations in which the user relinquishes physical possession of their credit card while at the same time being unable to identify how the credit card is being used. For example, in a situation repeated hundreds of thousands of time a day, a customer in a restaurant receives a check from the server, and the customer freely gives the customer's credit card to the server. The server then leaves the sight of the customer with the credit card and later returns with the credit card and a credit card slip to be signed by the customer, who has the option of including a tip. Once the credit card slip has been signed, the customer leaves, and the server retrieves the signed credit card slip.

In almost all instances, the server uses the credit card in a responsible manner. However, the customer loses control of the credit card once the server takes the credit card. As a result, the customer has no control of where the server goes or what the server does with the credit card or credit card information. Once in physical possession of the credit card, the server has the credit card number, the security code, the card expiration date, and the customer's signature, which allows the server to either make fraudulent charges on the credit card and/or to make copies of the card, the security code, and the customer's signature. This copied information may either be used by the server to subsequently make fraudulent charges or be sold to someone else who may act fraudulently. Also, the server is responsible for entering the tip information into the credit card system. In this situation, there is the possibility of a fraudulent tip amount being added to the credit card system, because there are few checks to ensure that the amount of the tip written on the credit card slip is the actual amount entered into the credit card processing system.

Unlike instances in which the consumer is immediately aware of the credit card being stolen, in the types of instances discussed above, it may take days or even months for a customer to discover that their credit card number was used for fraudulent purchases. In certain instances, the customer may not even realize that an extra amount was added to the tip or that an extra charge was made on the credit card. Even if the fraudulent charges are discovered, the customer, the credit card provider, and the merchant must all take time out to investigate the matter to determine whether or not to remove the charges from the customer's credit card. The customer, in certain circumstances, may even be responsible for the fraudulent purchases.

### BRIEF SUMMARY OF THE INVENTION

Embodiments of the disclosure address deficiencies of the art with respect to reducing fraudulent activities in situations in which a customer would normally be forced to relinquish physical control of a credit card to complete a transaction. These and other deficiencies are addressed by employing a method as described in the present disclosure, using a computer and visual scanning device attached to the computer. A visual invoice from a provider is scanned with the visual scanning device, and the visual invoice includes an optically readable symbol. The request is sent to a trusted agent (e.g. customer credit card company, financial institution, etc.) using the optically readable symbol. An electronic invoice is received from the trusted agent based upon the request. The electronic invoice is then approved.

Additional aspects of the disclosure will be set forth in part in the description which follows, and in part will be obvious from the description, or may be learned by practice of the embodiments. Further, the embodiments may be realized and attained by means of the elements and combinations particularly pointed out in the appended claims. It is to be understood that both the foregoing general description and the following detailed description are exemplary and explanatory only and are not restrictive of the invention, as claimed.

[enter prose of claims when claims are finalized]

The foregoing summary is illustrative only and is not intended to be in any way limiting. In addition to the illustrative aspects, embodiments, and features described above, further aspects, embodiments, and features will become apparent by reference to the drawings and the following detailed description

### BRIEF DESCRIPTION OF THE SEVERAL VIEWS OF THE DRAWINGS

The accompanying drawings, which are incorporated in and constitute part of this specification, illustrate embodiments of the invention and together with the description serve to explain the principles of the present disclosure. The embodiments illustrated herein are presently preferred, it being understood, however, that the invention is not limited to the precise arrangements and instrumentalities shown, wherein:

FIG. 1 is a schematic illustration of an exemplary payment processing system using an exemplary visual invoice;

FIG. 1A is a schematic illustration of an exemplary visual invoice;

FIG. 2 is a flowchart of an exemplary process, by a consumer, for paying the exemplary visual invoice;

FIG. 3 is a flowchart of an exemplary process, by a provider, for receiving payment for the exemplary visual invoice;

FIG. 4 is a flowchart of an exemplary process, by a trusted agent, for processing payment for the invoice;

FIG. 5 is an exemplary functional block diagram of an exemplary customer computer device that may scan an optically readable symbol that is part of a visual invoice using a visual scanning device to facilitate payment of the visual invoice;

FIG. 6 is an exemplary functional block diagram of an exemplary remote computer server that includes a database and functions that facilitates the translating, mapping, or otherwise correlation of an optically readable symbol with associated payment information;

FIG. 7 is an exemplary functional block diagram of an exemplary trusted agent computer device that provides payment information to an exemplary customer computer device and an exemplary provider computer device; and

FIG. 8 is an exemplary functional block diagram of an exemplary provider computer device that provides a visual invoice including an optically readable symbol and processes payment based on the optically readable symbol.

### DETAILED DESCRIPTION OF THE INVENTION

In the following detailed description, reference is made to the accompanying drawings, which for a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of difference configurations, all of which are explicitly contemplated herein. Further, in the following description, numerous details are set forth to further describe and explain one or more embodiments. These details include system configurations, block module diagrams, flowcharts (including transaction diagrams), and accompanying written description. While these details are helpful to explain one or more embodiments of the disclosure, those skilled in the art will understand that these specific details are not required in order to practice the embodiments.

System Overview

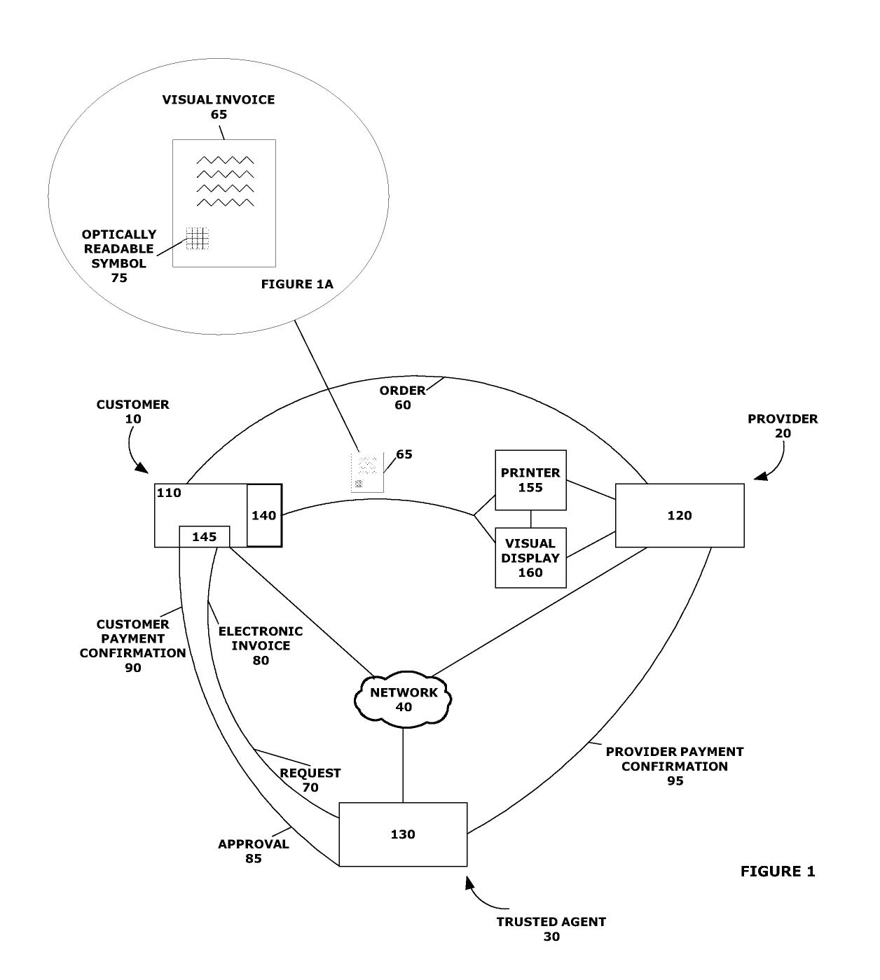

FIG. 1 schematically illustrates a system for using optically readable symbols to effectuate payment of a visual invoice (e.g. check, bill, etc.) 65 using a customer computer device 110 and a visual scanning device 140 attached to the customer computer device (e.g. smartphone, PDA, tablet PC, mobile phone, etc.) 110. The visual scanning device (e.g. digital camera, bar code scanner, etc.) 140 scans the visual invoice 65 provided to a customer 10 by a provider 20, and the visual invoice 65 includes an optically readable symbol 75. The customer 10 sends a request 70, to a trusted agent 30, using the optically readable symbol 75.

After the request 70 is sent to the trusted agent 30, the customer 10 receives, from the trusted agent 30, an electronic invoice 80 based upon the request 70. The customer 10 then generates an approval 85 for the electronic invoice 80. After the approval 85 is sent to the trusted agent 30, the provider 20 may be notified with a provider payment confirmation 95 from the trusted agent 30 that payment has been effectuated by the customer 10 and the customer 10 can similarly be notified with a customer payment confirmation 90.

### EXAMPLES

The present system, for example, could be employed in the context of a restaurant. In such a context, the customer 10 would be a patron of the restaurant and the provider 20 would be the restaurant itself. After an order 60 has been placed for the meal, instead of paying for the meal with credit card or cash, the meal can be paid using the present system, which would entail a visual invoice 65 including the optically readable symbol 75 being presented to the patron. The patron would then scan the visual invoice 65 with a portable computer device 110 (e.g. a smart phone, PDA, tablet) to obtain the optically readable symbol 75.

Alternative embodiments may include a visual invoice having an optically readable symbol on a printed visual invoice or an invoice presented on a visual display. Further, a customer computing device having the visual scanning device may scan or retrieve the optically readable symbol. In addition, the customer computing device having a computer processing module with computer processing software decodes the symbol or alternatively using communications module on the device (WiFi, cellular, satellite, etc) having one or more communication interfaces, sends the optically readable symbol to a remote server for decoding. The remote server may decode the optically readable symbol into a decoding string, the decoding string may be sent to a database server where the decoding string is identified using database software (oracle, Microsoft sql, etc) and is mapped to payment information. Then the payment information can be sent to the trusted agent for processing. Further, the trusted agent provides an electronic invoice to the customer who may then approve payment and optionally provides other information (quality of service and goods, and gratuity information).

Data obtained from the optically readable symbol 75 would be used by the customer 10 to contact the trusted agent 30 to effectuate payment. Once payment has been made, the customer 10 and/or the restaurant (i.e. the provider 20) can receive payment confirmation 90, 95, respectively, that the payment has been made. In this manner, the customer's payment information (e.g. credit card number, bank account) is not shared with the restaurant, which prevents possible fraudulent use of this information.

As another example, the present system can be employed in the context of a roadside stand. In these instances, the provider 20 (e.g. the stand, a delivery truck, etc.) often does not have access to a landline with which normal credit card operations can be employed. The provider 20, however, can display the visual invoice 65 on a visual display 160 of smart phone, tablet, etc., which can then be scanned by the customer's portable computer device 110. In so doing, the customer's credit card information is not shared with the provider 20. The provider 20 can still take electronic payment without the need for additional equipment associated with a normal credit card transaction. Moreover, by using a visual exchange of data instead of an electronic exchange of data (e.g. a Bluetooth connection or IR data exchange), both the customer's and provider's respective computer devices 110, 120 are protected from being electronically compromised (e.g. hacked) by the other device.

Provider

The provider 20 is not limited to one person or one entity. The provider 20 can be any party that can generate a visual invoice 65 with an optically readable symbol 75, including but not limited to a vendor, a software developer, a credit card company, a financial institution, a credit card clearing house, a credit card processing company, or a restaurant. For example, a restaurant can create a paper-printed check with an optically readable symbol 75 itself or the restaurant can use another party, such as a vendor or even another restaurant, to generate the paper-printed check with an optically readable symbol 75.

Trusted Agent

The trusted agent 30 can be any party that can generate the electronic invoice 80, including but not limited to a vendor, a software developer, a credit card company, a financial institution, a credit card clearing house, a credit card processing company, or the provider 20. In addition, the trusted agent 30 may be more than one party. For example, one party may generate the electronic invoice 80, but another party may process payment of the electronic invoice 80. In such a context, a vendor, having the sole function to generate electronic invoices 80, may generate the electronic invoice 80, but a credit card company may process the payment of the electronic invoice 80. Payment information and methods of payment and payment processing is not limited to credit cards but includes debit cards, direct debit from checking account, etc.

### Visual Scanning Device

The type of visual scanning device 140 used to scan the visual invoice 65 is not limited. For example, the visual scanning device 140 can include a digital camera, a video camera, a laser, a charged couple device (CCD), bar code reader or an optical scanning device. Scanning the visual invoice 65 retrieves information associated with the optically readable symbol 75. This information includes but is not limited to vendor name and associated information transaction date, transaction information, principal amount due, gratuity information, end user identifier (e.g. table number), provider name, and provider contact information. Other information can include but is not limited to the product(s) and/or service(s) ordered, customer order number, or price. A section may also include a solicitation for customer feedback on quality of service or goods.

Visual Invoice

FIG. 1A is a schematic illustration of a visual invoice 65 with an optical readable symbol 75. The visual invoice 65 presented to the customer 10 or the customer's computer device 110 by the provider 20 or the provider's computer device 120 can be printed or electronic digital form. For example, in the context of a restaurant or food service environment, a restaurant (the provider 20) can provide the customer 10 a bill (the visual invoice 65) on any material, including a paper-printed check or a hand-written check. As another example, in the context of a roadside stand, the provider 20 can display the visual invoice 65 directly on a visual display 160 of a smart phone, tablet, etc in digital form.

The invoice information contained on the visual invoice 65 is not limited. The invoice information may include provider's 20 name, transaction date, principal amount due, gratuity amount due, Internet Protocol (IP) address, identifier, or provider's 20 contact information—such as name, address, phone number, and email address. If the present system is employed in the context of a restaurant, the electronic invoice 80 may further include but is not limited to customer identifier (e.g. table number), server's identifying information, and restaurant's contact information, such as name, address, phone number, and email address.

Electronic Invoice

The invoice information contained in the electronic invoice 80 provided to the customer 10 or to the customer's computer device 110 by the trusted agent 30 or the trusted agent's computer device 130 is not limited. The invoice information may include provider's 20 name, transaction date, principal amount due, gratuity amount due, Internet Protocol (IP) address, identifier, or provider's 20 contact information, such as name, address, phone number, and email address. If the present system is employed in the context of a restaurant, the electronic invoice 80 may further include but is not limited to customer identifier (e.g. table number), server's identifying information, and restaurant's contact information, such as name, address, phone number, and email address. A section may also include a solicitation for customer feedback on quality of service or goods.

Optically Readable Symbol

The type of optically readable symbol 75 is not limited. For example, the optically readable symbol 75 can be a bar code, a UPC (Universal Product Code), code 93, Aztec code, QR codes, and Microsoft Tag codes, or datamatrix 2D codes. The optically readable symbol 75 can also be composed of a combination of symbols. In another embodiment of this disclosure the entire invoice could be used as the optically scannable symbol using visual search and recognition technology which is known in the art.

Network Communications

The manner in which either the customer 10 or the provider 20 contacts the trusted agent 30 is not limited. Typically, the customer 10 and the provider 20 connect with the trusted agent 30 over some type of one or more networks 40 (e.g., the internet, wireless network). Communication between the customer 10, the provider 20, the trusted agent 30 and/or their respective computer devices, 110, 120, and 130, is not limited to one type of communication, but can include, for example, cellular 4G, 3G, Wi-Fi, radio frequency, satellite, or microwave.

Consumer Process

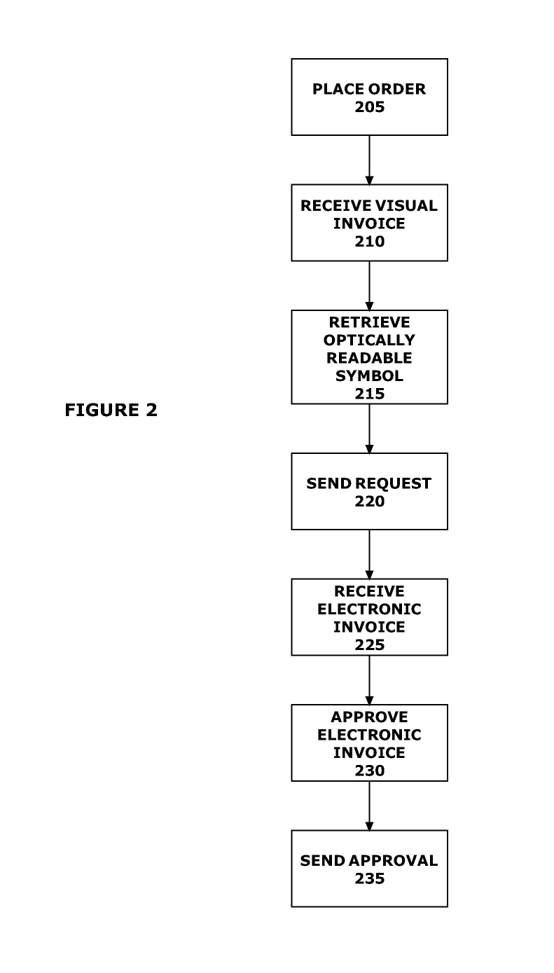

Referring to FIG. 2, a flowchart of the process for paying an invoice, as performed by the customer 10 and/or the customer computer device 110, is illustrated. In block 205, an order 60 for a product and/or service is placed, and the manner in which the order 60 is placed is not limited. For example, the order 60 may be placed directly by the customer 10 or the ordering may be placed using the customer computer device 110 interacting with the provider computer device 120 over a communication network, for example. In block 210, the customer 10 receives a visual invoice 65 from the provider 20. As previously discussed, the visual invoice 65 can be presented to the customer 10 in a variety of different manners. For example, the visual invoice 65 can be printed out and presented directly to the customer 10. As another example, the visual invoice 65 can be displayed, on a visual display 160, to the customer 10 on the customer's display device including a cellular phone, PDA, etc. over a communication network.

In block 215, using the visual scanner 140 of the customer's computer device 110, the customer 10 retrieves the optically readable symbol 75 from the visual invoice 65. The customer 10 may retrieve the optically readable symbol 75 using the visual scanner 140 to scan the optically readable symbol 75. In block 220, based upon information obtained from the optically readable symbol 75, the customer's computer device 110 sends a request 70 to the trusted agent 30. The customer's computer device 110 may perform a handshake with the trusted agent computer device 130. As is well-known in the art, handshakes can include exchanging authentication information between the parties 10, 30. This handshake can also include the customer 10 sending, either directly or indirectly, payment information and customer service feedback on quality of service or goods, to the trusted agent computer device 130. Communication between the customer's computer device 110 and the provider's computer device 120 or the trusted agent's computer device 130 is not limited to a handshake. Communication between any of the devices 110, 120, or 130 can be via any type of one or more communication networks 40 (e.g. the internet, intranet, wireless network).

In block 225, the customer 10, via the customer's computer device 110, receives an electronic invoice 80 from the trusted agent's computer device 130. In block 230, the customer 10 using the customer's computer device 110 approves the electronic invoice 80. At this time, the customer 10 may choose to adjust the total (e.g. leave a tip). Also, if not already previously performed, the customer 10 may also choose to select a form of payment, which would then be included in an approval 85. The customer can also provide customer feedback information including quality of service and quality of goods information. Once approved, in block 235, the approval 85 is sent by the customer's computer device 110 back to the trusted agent 30 and/or to the trusted agent's computer device 130. The customer and/or the customer's computer device 110 may receive a customer payment confirmation 90 that the electronic invoice 80 was successfully processed.

Provider Process

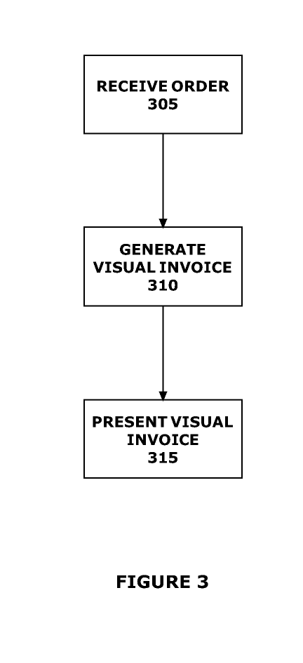

Referring to FIG. 3, a flowchart of the process for receiving payment for an invoice, as performed by the provider 20 and/or the provider computer device 120, is illustrated. In block 305, an order 60 for a product and/or service is received, and the manner in which the order 60 is placed is not limited. For example, the order 60 may be placed directly by the customer 10 or the ordering may be placed using the customer's computer device 110 interacting with the provider's computer device 120. In block 310, the provider 20 generates a visual invoice 65 including the optically readable symbol 75. As part of this operation, the provider 20 may use the trusted agent 30 to generate the visual invoice 65 and/or provide the trusted agent 30 with certain information from the visual invoice 65.

In block 315, the visual invoice 65 is presented to the customer 10. As previously discussed, the visual invoice 65 can be presented to the customer 10 in a variety of different manners. For example, the visual invoice 65 can be printed out and presented directly to the customer 10. As another example, the visual invoice 65 can be displayed, on a visual display 160, to the customer 10 over a communication network. The provider 20 may receive, via the provider's computer device 120, a provider payment confirmation 95 that indicates that payment of the visual invoice 65 has occurred.

Trusted Agent Process

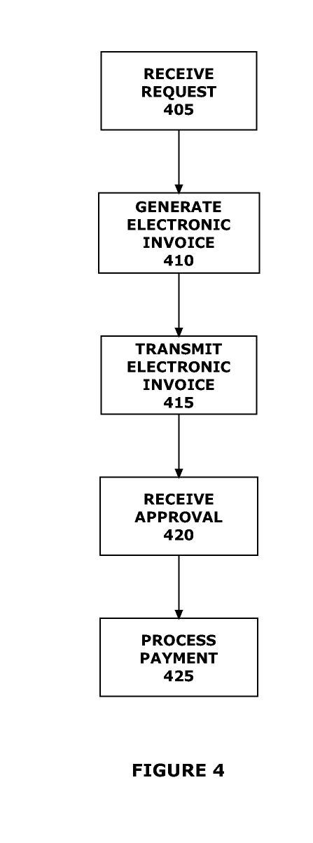

Referring to FIG. 4, a flowchart of the process for processing payment for an invoice, as performed by the trusted agent 30 and trusted agent computer device 130, is illustrated. In block 405, the trusted agent's computer device 130 receives a request 70 from the customer's computer device 110. The request 70 includes information used to create an electronic invoice 80. Invoice information from the visual invoice 65 may also be received from the provider 20. The information provided by the provider 20 can also be used to create the electronic invoice 80 and/or verify the information provided by the customer computer device 110. As previously discussed, the information used to create the electronic invoice 80 and the information contained in the electronic invoice 80 can include but is not limited to amount due, customer 10 information, and provider 20 information.

The trusted agent computer device 130 may perform a handshake with the customer computer device 110. As is well-known in the art, handshakes can include exchanging authentication information between the parties 10, 30. This handshake can also include the trusted agent's computer device 130 receiving, either directly or indirectly, a form of payment information from the customer 10. It can also include receiving customer feedback information from the customer, As previously indicated, communication between the customer's computer device 110 and the provider's computer device 120 or the trusted agent's computer device 130 is not limited to a handshake. Communication between any of the devices 110, 120, or 130 can be via any type of one or more networks 40 (e.g. the internet, wireless network). In block 410, the electronic invoice 80 is generated, and in block 415, the electronic invoice 80 is transmitted to the customer's computer device 110.

In block 420, the trusted agent's computer device 130 receives an approval 85 from the customer 10, via the customer's computer device 110. Once the approval 85 has been received, the trusted agent's computer device 130 processes payment of the electronic invoice 80 based upon the information contained within the approval 85, as shown in block 425. Once payment has been effectuated, the trusted agent's computer device 130 can send payment confirmations 90, 95, respectively, to the client 10 and/or to the client's computer device and to the provider 20 and/or to the provider's computer device.

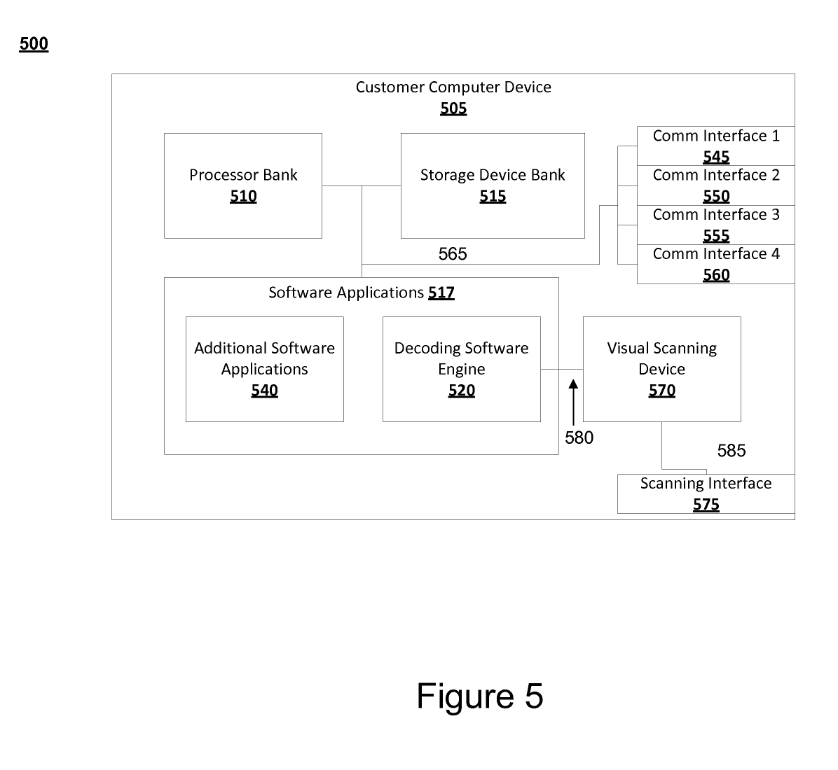

FIG. 5 is an exemplary functional block diagram 500 of a customer computer device 505 that may scan an optically readable symbol that is part of a visual invoice using a visual scanning device 570 to facilitate payment of the visual invoice as described in the present disclosure. Further, the customer computer device 505 may decode the optically readable symbol using a decoding software engine 520. The customer computer device 505 may include several different components such as a processor bank 510, storage device bank 515, one or more software applications 517, and one or more communication interfaces (545-560). The processor bank 510 may include one or more processors that may be co-located with each other or may be located in different parts of the customer computer device 505. The storage device bank 515 may include one or more storage devices. Types of storage devices may include memory devices, electronic memory, optical memory, and removable storage media. The one or more software applications 517 may include the decoding software engine 520 and additional software applications 540.

The customer computer device 505 facilitates payment of an invoice as described in the present disclosure. An order for a product and/or service is placed in one or a variety of different ways. For example, the order may be placed directly by the customer or the ordering may be placed using the customer computer device 505 interacting with a provider computer device over a communication network, for example. Further, the customer may receive a visual invoice from the provider. As previously discussed, the visual invoice can be presented to the customer in a variety of different manners. For example, the visual invoice can be printed out and presented directly to the customer. As another example, the visual invoice can be displayed, on a visual display 160 or to the customer on the customer's display device including a cellular phone, PDA, etc over a communication network.

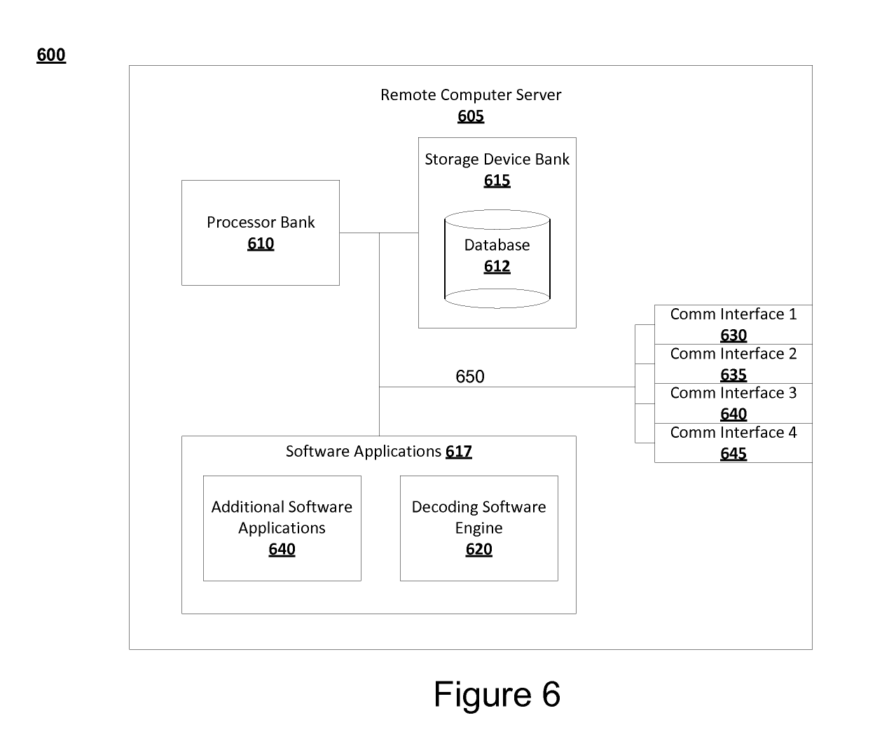

In addition, using the visual scanning device 570 of the customer computer device 505, the customer may scan or retrieve an optically readable symbol from the visual invoice. The visual scanning device 570 may be coupled to a scanning interface 575 that may scan or retrieve the optically readable symbol. The scanning interface 575 may be a camera, bar code reader, or any other scanning device known in the art. Further, the scanning interface 575 may forward the retrieved optically readable symbol to the visual scanning device 570 for processing. After processing the optically readable symbol, the visual scanning device 570 may forward the optically readable symbol to the decoding software engine 520. The decoding engine 520 may communicate, including transmitting the optically readable symbol with a remote computer server (See FIG. 6) across a communication network through one or more communication interfaces (545-560). The remote computer server may have server decoding software and/or a database that translates, maps, or otherwise correlates the optically readable symbol with a payment amount. Further, the payment amount is decoded by the decoding software engine 520 or may be decoded by the remote computer server and received by the customer computer device across the communication network through one or more communication interfaces (545-560).

In addition, based upon payment information obtained by decoding the optically readable symbol, the customer computer device 505 may send a request to a trusted agent computer device across a communication network through one or more communication interfaces (545-560) using one of the additional software applications 540. The customer computer device 505 may also perform a handshake with the trusted agent computer device with the additional software applications 540. As is well-known in the art, handshakes can include exchanging authentication information between the parties. Such a handshake can also include the customer sending, either directly or indirectly, payment information and customer service feedback on quality of service or goods, to the trusted agent computer device. Communication between the customer computer device 505 and the provider computer device or the trusted agent computer device is not limited to a handshake. Communication between any of the devices can be via any type of one or more communication networks (e.g. the Internet, intranet, wireless network).

Further, the customer computer device 505, may receive an electronic invoice from the trusted agent computer device. The customer using the customer computer device 505 may approve the electronic invoice. At such time, the customer may choose to adjust the total (e.g. leave a tip) payment amount on the electronic invoice. Also, if not already previously performed, the customer may also choose to select a form of payment, which would then be included in an approval. The customer computer device 505 can also provide customer feedback information including quality of service and quality of goods information. Once approved, the approval is sent by the customer computer device 505 back to the trusted agent computer device. The customer (across the communication network through one or more communication interfaces (545-560)) and/or the customer computer device 505 may receive a customer payment confirmation that the electronic invoice was successfully processed.

Each of the communication interfaces (545-560) shown in FIG. 5 may be software or hardware associated in communicating to other devices or to a customer through a user interface. The communication interfaces (545-560) may be of different types that include a user interface, USB, Ethernet, WiFi, WiMax, wireless, optical, cellular, or any other communication interface coupled to a communication network.

Intra-device communication links (565, 580, 585) between the processor bank 510, storage device bank 515, software applications 517, and communication interfaces (545-560) as well as between the scanning interface 575, visual scanning device 570 and the decoding software engine 520 may be one of several types that include a bus or other communication mechanism.

FIG. 6 is an exemplary functional block diagram 600 of a remote computer server 605 that includes a database and functions that facilitates the translating, mapping, or otherwise correlation of an optically readable symbol with associated payment information. The remote computer server 605 may include several different components such as a processor bank 610, storage device bank 615, one or more software applications 617, and one or more communication interfaces (630-645). The processor bank 610 may include one or more processors that may be co-located with each other or may be located in different parts of the remote computer server 605. The storage device bank 615 may include one or more storage devices. Types of storage devices may include memory devices, electronic memory, optical memory, and removable storage media. A database 612 having one or more optically readable symbols each optically readable symbol having a mapping to an associated payment information may be stored in one of the storage devices 615 within the remote computer server 605. The one or more software applications 617 may include a decoding software engine 630 and additional software applications 640. The decoding software engine 620 translates, maps, or otherwise correlates the optically readable symbol with a payment amount using the database 612. The decoded payment amount may be transmitted to a customer computer device across the communication network through one or more communication interfaces (630-645) using one of the additional software applications or functions 640.

Each of the communication interfaces (630-645) shown in FIG. 6 may be software or hardware associated in communicating to other devices or to a remote computer server user. The communication interfaces (630-645) may be of different types that include a user interface, USB, Ethernet, WiFi, WiMax, wireless, optical, cellular, or any other communication interface coupled to a communication network.

An intra-device communication link 650 between the processor bank 610, storage device bank 615, software applications 617, and communication interfaces (630-645) may be one of several types that include a bus or other communication mechanism.

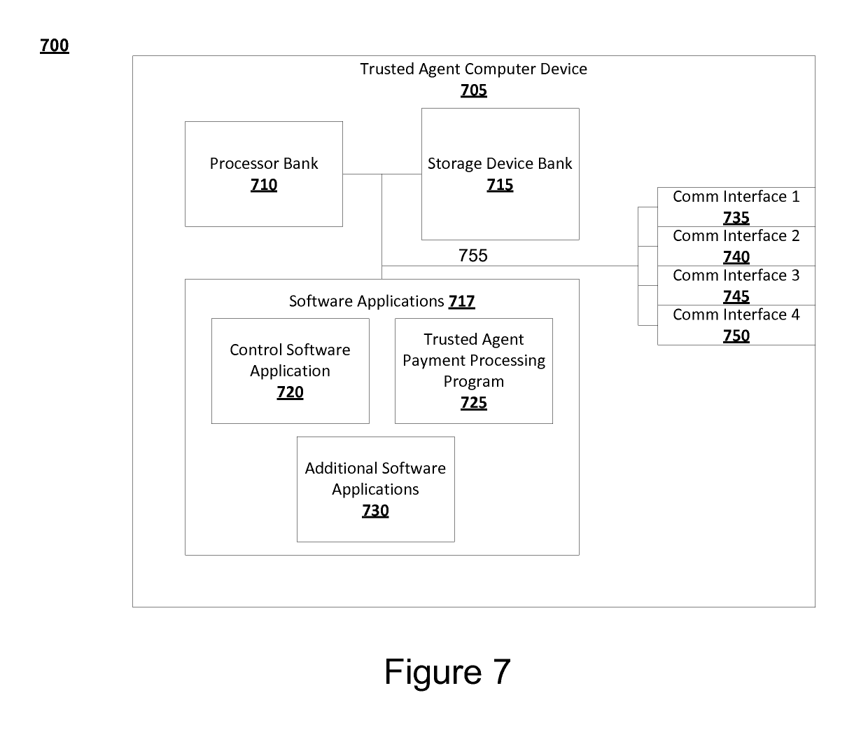

FIG. 7 is an exemplary functional block diagram 700 of a trusted agent computer device 705 that provides payment information to a customer computer device and a provider computer device. The trusted agent computer device 705 may include several different components such as a processor bank 710, storage device bank 715, one or more software applications 717, and one or more communication interfaces (735-750). The processor bank may include one or more processors that may be co-located with each other or may be located in different parts of the trusted agent computer device 705. The storage device bank 315 may include one or more storage devices. Types of storage devices may include memory devices, electronic memory, optical memory, and removable storage media. The one or more software applications 717 may include a control software application 720, trusted agent payment processing program 725, and additional software applications 730. The control software application 720 may implement software functions that facilitate the functions of the trusted agent computer device 705 such as transmitting and receiving information across a communication network through one or more communication interfaces (735-750).

The trusted agent computer device 705 may receive a request from a customer computer device across the communication network through one or more communication interfaces (735-750). The request may include information that may be used to create an electronic invoice using the trusted agent payment processing program 725. The information may also be received from a provider computer device across the communication network and can also be used to create the electronic invoice and/or verify the information provided by the customer computer device using the trusted agent payment processing program 725. As previously discussed, the information used to create the electronic invoice and the information contained in the electronic invoice can include but is not limited to amount due, customer information, and provider information.

The trusted agent computer device 705 may perform a handshake with the customer computer device using the control software application 720 or the additional software applications 730. As is well-known in the art, handshakes can include exchanging authentication information between the parties. Such a handshake can also include the trusted agent computer device 705 receiving, either directly or indirectly, a form of payment information from the customer. It can also include receiving customer feedback information from the customer. As previously indicated, communication between the customer computer device and the provider computer device or the trusted agent computer device 705 is not limited to a handshake. Communication between any of the devices can be via any type of one or more networks (e.g. the internet, wireless network). Further, an electronic invoice is generated based on the received request, and the electronic invoice is transmitted to the customer computer device across the communication network through one or more communication interfaces (735-750).

In addition, the trusted agent computer device 705 may receive an approval from the customer via the customer computer device across the communication network through one or more communication interfaces (735-750). Once the approval has been received, the trusted agent's computer device 130 processes payment of the electronic invoice based upon the information contained within the approval using the trusted agent payment processing program 725. Once payment has been effectuated, the trusted agent computer device 705 can send payment confirmations to the customer computer device and to the provider computer device across the communication network through one or more communication interfaces (735-750).

Each of the communication interfaces (735-750) shown in FIG. 7 may be software or hardware associated in communicating to other devices or to a trusted agent computer device user. The communication interfaces (735-750) may be of different types that include a user interface, USB, Ethernet, WiFi, WiMax, wireless, optical, cellular, or any other communication interfaces coupled to a communication network.

An intra-device communication link 755 between the processor bank 710, storage device bank 715, software applications 717, and communication interfaces (735-750) may be one of several types that include a bus or other communication mechanism.

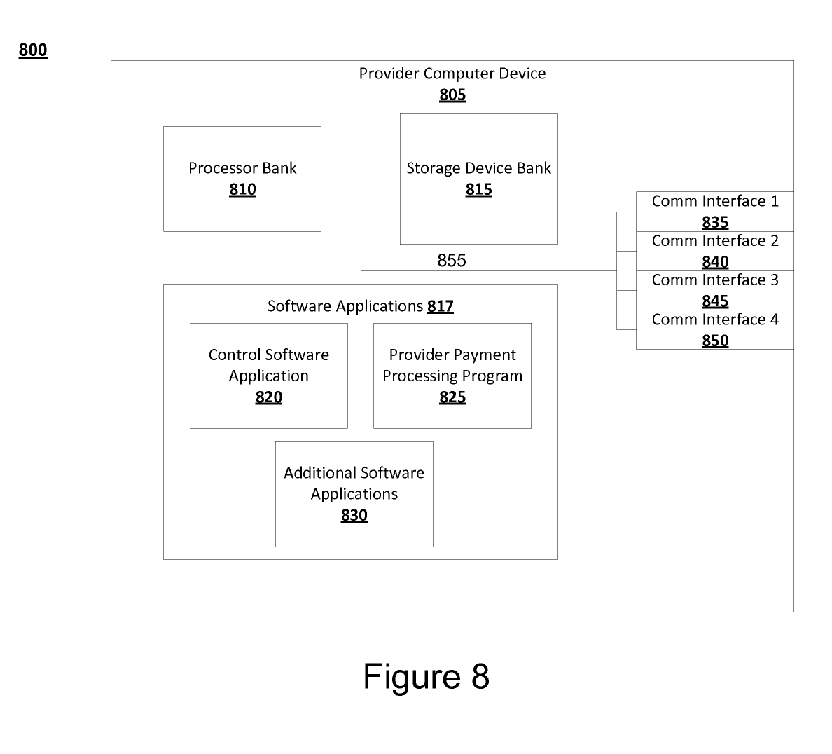

FIG. 8 is an exemplary functional block diagram 800 of a provider computer device 805 that provides a visual invoice including an optically readable symbol and processes payment based on the optically readable symbol. The provider computer device 805 may include several different components such as a processor bank 810, storage device bank 815, one or more software applications 817, and one or more communication interfaces (835-850). The processor bank 810 may include one or more processors that may be co-located with each other or may be located in different parts of the provider computer device 805. The storage device bank 815 may include one or more storage devices. Types of storage devices may include memory devices, electronic memory, optical memory, and removable storage media. The one or more software applications 817 may include a control software application 820, provider payment processing program 825, and additional software applications 830. The control software application 820 and the additional software applications 830 may implement software functions that facilitate the functions of the provider computer device 805 such as transmitting and receiving information across a communication network through one or more communication interfaces (835-850).

The provider computer device may facilitate a process for receiving payment for an invoice. An order for a product and/or service may be received by the provider computer device 805, and the manner in which the order is placed is not limited. For example, the order may be placed directly by a customer or the ordering may be placed using a customer computer device interacting with the provider computer device 805 through one or more communication interfaces (835-850). Further, the provider computer device 805 may generate a visual invoice including the optically readable symbol 75 using the provider payment processing program 825. As part of this operation, the provider computer device 805 may communicate with a trusted agent computer device over a communication network through one or more communication interfaces (835-850) to generate the visual invoice and/or provide the trusted agent computer device with certain information from the visual invoice. In addition, the visual invoice is presented to the customer. As previously discussed, the visual invoice can be presented to the customer in a variety of different manners. For example, the visual invoice can be printed out and presented directly to the customer. As another example, the visual invoice can be displayed, on a visual display to the customer over a communication network. Further, the provider computer device 805 may receive and then process a provider payment confirmation using the provider payment processing program 825, the payment confirmation indicating that payment of the visual invoice has occurred.

Each of the communication interfaces (835-850) shown in FIG. 8 may be software or hardware associated in communicating to other devices or to a user. The communication interfaces (835-850) may be of different types that include a user interface, USB, Ethernet, WiFi, WiMax, wireless, optical, cellular, or any other communication interfaces coupled to a communication network.

An intra-device communication link 855 between the processor bank 810, storage device bank 815, software applications 817, and communication interfaces (835-850) may be one of several types that include a bus or other communication mechanism.

Note that the functional blocks, methods, devices and systems described in the present disclosure may be integrated or divided into different combination of systems, devices, and functional blocks as would be known to those skilled in the art.

In general, it should be understood that the circuits described herein may be implemented in hardware using integrated circuit development technologies, or yet via some other methods, or the combination of hardware and software objects that could be ordered, parameterized, and connected in a software environment to implement different functions described herein. For example, the present application may be implemented using a general purpose or dedicated processor running a software application through volatile or non-volatile memory. Also, the hardware objects could communicate using electrical signals, with states of the signals representing different data.

It should be further understood that this and other arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions, or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for providing electronic payment using an optically readable symbol, the method comprising:
(a) scanning a visual invoice using a visual scanning device for an optically readable symbol wherein the visual invoice includes an optically readable symbol;
(b) transmitting a request to a customer-trusted agent communication interface, the request including the optically readable symbol;
(c) decoding the optically readable symbol and processing the optically readable symbol to generate an amount due;
(c) receiving an electronic invoice based on the request from the customer-trusted agent communication interface wherein the electronic invoice includes the amount due;
(d) sending an approval for the electronic invoice to customer-trusted agent communication interface wherein the approval includes payment information.

2. The method of claim 1, wherein the scanning retrieves invoice information associated with the optically readable symbol.

3. The method of claim 1, wherein the scanning includes scanning the entire visual invoice as the optically readable symbol.

4. The method of claim 1, wherein information listed in the visual invoice is selected from the group consisting of an address of the trusted agent, an identifier of the visual invoice. an amount due, a solicitation for customer input on service and quality of goods.

5. The method of claim 1, wherein the approval of the electronic invoice includes an adjusted the amount due wherein the adjusted amount due is forwarded to the customer-trusted agent communication interface.

6. The method of claim 1, wherein the approval includes customer feedback information.

7. The method of claim 1, wherein the visual invoice is selected from the group consisting of printed material and an electronic form displayed on a mobile computing device.

8. The method of claim 1, wherein the visual scanning device is selected from the group consisting of a digital camera and a bar code reader.

9. A method for providing electronic payment using an optically readable symbol, the method comprising:
(a) receiving a request from a trusted agent-customer communication interface wherein the request includes an optically readable symbol;
(b) generating and transmitting an electronic invoice to trusted agent-customer communication interface wherein the electronic invoice includes an amount due based on the optically readable symbol;
(c) receiving an approval of the electronic invoice from the trusted agent-customer communication interface wherein the approval includes payment information; and
(d) processing payment information.

10. The method of claim 9, wherein approval the electronic invoice includes an adjusted the amount due wherein the adjusted amount due is received to the trusted agent-customer communication interface.

11. The method of claim 9, wherein the approval includes customer feedback information.

12. A system for providing electronic payment using an optically readable symbol, the system comprising:
(a) a communication network;
(b) a customer computing device having a visual scanning device, the customer computing device coupled to the communication network;
(c) a provider computing device coupled to the communication network;
(d) wherein the provider computing device: (i) receives an order from the customer computer device; (ii) generates a visual invoice including the optically readable symbol based on the order; and (iii) transmits the visual invoice to the customer computing device over the communication network.

13. The system of claim 12, the system further comprising a trusted agent computing device coupled to the communication network.

14. The system of claim 13, wherein the customer computing device:
(a) receives the visual invoice from the provider computing device;
(b) retrieves the optically readable symbol using the visual scanning device;
(c) decodes the optically readable symbol and processes the optically readable symbol to generate the amount due;
(d) sends a request to the trusted agent computing device.

15. The system of claim 14, wherein the trusted agent computing device receives the request from the customer computing device, processes the request and sends an electronic invoice to the customer computing device based on the request.

16. The system of claim 15, wherein the customer computing device receives the electronic device and sends an approval to the trusted agent computing device.

17. The system of claim 16, wherein the trusted agent computing device receives the approval, processes payment based on the approval and provides payment information to the provider computing device.

18. The system of claim 17, wherein the visual invoice includes a solicitation for customer input on service and quality of goods and the customer computing device provides customer feedback based on the solicitation to the trusted agent computing device and the trusted agent computing device provides the customer feedback to the provider computing device.

19. The system of claim 12, wherein the entire visual invoice is the optically readable symbol.

20. The system of claim 12, wherein the visual scanning device is selected from the group consisting of a digital camera and a bar code reader.
